(19) United States
(12) Patent Application Publication
(10) Pub. No.: US 2018/0365411 A1
(43) Pub. Date: Dec. 20, 2018

(54) METHOD AND SECURITY MODULE FOR PROVIDING A SECURITY FUNCTION FOR A DEVICE

(71) Applicant: SIEMENS AKTIENGESELLSCHAFT, München (DE)

(72) Inventors: Rainer FALK, Poing (DE); Steffen FRIES, Baldham (DE); Markus HEINTEL, München (DE); Dominik MERLI, Mertingen (DE); Stefan PYKA, Markt Schwaben (DE)

(73) Assignee: Siemens Aktiengesellschaft, Muenchen (DE)

(21) Appl. No.: 16/060,497

(22) PCT Filed: Nov. 28, 2016
(86) PCT No.: PCT/EP2016/079004

§ 371 Date: Jun. 8, 2018

(30) Foreign Application Priority Data
Dec. 15, 2015 (DE) 10 2015 225 270.1

(51) Int. Cl. G06F 21/51; H04L 29/06; G06F 21/74; G06F 21/44

(52) U.S. Cl. CPC G06F 21/51; H04L 63/123; G06F 21/44; H04L 63/0884; G06F 21/74

(57) ABSTRACT

A method for providing a security function, in particular a cryptographic function, for a device, wherein the following method steps are carried out: receiving a request to execute the security function; loading a security application for the security function via a control application, wherein the control application is stored on a first internal memory of a security module and the security application is transferred from a memory which is external to the security module; checking an integrity of the security application by means of security information; executing the security application and providing the security function, wherein the execution and provision steps are carried out after the successful integrity checking step.

### CROSS-REFERENCE TO RELATED APPLICATIONS

This application claims priority to PCT Application No. PCT/EP2016/079004, having a filing date of Nov. 28, 2016, based off of German application No. 102015225270.1 having a filing date of Dec. 15, 2015, the entire contents of both of which are hereby incorporated by reference.

### FIELD OF TECHNOLOGY

The following relates to a method and a security module for the cryptographic protection of devices.

### BACKGROUND

Devices, for example embedded systems, can be currently found in all branches of industry. The (cryptographic) protection of these devices plays an increasingly important role in order to ensure a secure operation. Cryptographic functions allow objectives such as integrity, confidentiality or authenticity of these platforms to be achieved. As a result, they protect against deliberate, targeted attacks.

One means of securing an embedded system is the integration of a hardware-based trust anchor. This can fulfill various tasks, for example, a security function can provide cryptographic keys to a security application at run time, create and test integrity checking values of application and configuration data, sign data, provide cryptographically strong random numbers, and much more.

In many cases, trust anchors only have very limited resources at their disposal, for example a small amount of working memory or flash memory. This means that the trust anchors can only be updated, for example to take account of changes in security standards, by complicated means.

### SUMMARY

A first aspect relates to a method and a security module, which provide security features to a device as flexibly and securely as possible.

According to a first aspect embodiments of the invention relate to a method for providing a security function, in particular a cryptographic function, for a device, wherein the following method steps are carried out:

In one method step a request to perform the security function is received. In a further method step a security application for the security function is loaded by means of a control application, wherein the control application is stored on a first internal memory of a security module and the security application is transferred from a memory external to the security module.

In a further method step, the integrity of the security application is verified by a security information item.

In a further method step, the security application is executed and the security function is provided, the execution and provision being performed after the successfully verification of the integrity.

A security application can be understood to mean, for example, a software library that comprises one or a plurality of security functions. Thus, a security application can only comprise a single security function, wherein in such a case, the expressions “security function” and “security application” can be regarded as synonymous.

The term (technical) device or (technical) system can be understood to mean, for example, a measuring device for high frequency technology, a receiving device of a satellite communication station, a field device of a power plant, a control unit, an embedded system, an IC (integrated circuit), an FPGA (field programmable gate array), an ASIC (application-specific integrated circuit), a microcontroller or a DSP (digital signal processor).

The steps of the method can be carried out, for example, using a computer-based processor.

The request can be generated, for example, by an operating system driver or operating system, which requires the security function. The request comprises, for example, a data structure which comprises the security application, user data, the security information, for example in the form of integrity information relating to the security application, and/or other information. The security application and the integrity information are preferably stored on the memory external to the security module and are sent to the security module, for example, by the operating system driver by means of the request.

The phrase “external to the security module” can be understood to mean components that are not an integral part of the security module.

The term internal, often also referred to as “internal to the security module”, can be understood to mean components or method steps that are either an integral part of the security module or are executed preferably exclusively on components internal to the security module.

For example, the loading and execution is executed at the runtime of the operating system and/or of the security module and/or the control application of the security module.

The term “loading” can be interpreted broadly in the context of the patent application. The term can be understood to include an alternative design, in which an additional security application is loaded. In another alternative design it can be understood to mean that a loaded security application is replaced, i.e. overwritten, by the newly loaded security application. In a further alternative design, the loading of an empty security application can cause a loaded security application to be deleted. This can be caused by a delete-load instruction.

The security module provides the security function as a result of the successful verification of, for example, an authorized requesting agent, in particular the operating system, the operating system driver, the security module itself, another security module, or a combination thereof. The security application or the security function in this case generate, for example, data that can be used by the requesting agent and/or the security module itself, for example for the later provision of an additional security function, and/or of a security application or security function which is loaded and executed later.

A security function can include, for example, cryptographic functions for creating a digital signature, for decrypting or encrypting a data structure, or functions for providing license information.

The disclosed method is advantageous compared to previous solutions, since it allows a dynamic exchange of (cryptographic) security functions or security applications, for example cryptographic functions, at the runtime of the operating system of the device. For example, the method allows a plurality of security functions to be provided by a security module, such as a trust anchor, where previously, for reasons of space, only a single security function or security application could be integrated. This means that the security module can be manufactured less expensively.

In a first embodiment of the method, the security appliance can be decrypted by means of a first cryptographic key before the verification.

To achieve this, the security application is available in encrypted form on the memory external to the security module, wherein the integrity information for the security application can also be encrypted. Here, symmetrical or asymmetrical methods can be used. The first cryptographic key is preferably stored on the first memory internal to the security module and protected against accesses external to the security module. This improves the security of the method. For example, the decryption can then be performed when loading or when verifying the integrity of the security application.

In further embodiments of the method, before the security application is verified a header information item of the security application can be checked for integrity. The security application can only be loaded after or as a result of the successful verification of the header information.

The header information may be included, for example, in the request together with the security application and the security information. The control application only loads the security application once the verification has been successful, and has the advantage that a loading operation of a potentially manipulated security application is aborted at an early stage, and therefore the security of the method is improved.

In further embodiments of the method, the security application can be transferred as a part of the request, a memory location of the security application can be transferred as a part of the request, or the security application can be loaded by the control application from the memory external to the security module.

The different variants of means for loading the security application allow, for example, the data source for the method to be selected flexibly.

In further embodiments of the method the security application can be loaded into a second internal memory for decryption, to verify the security application or to verify the header information.

This can increase the security of the method in order to prevent, for example, malicious program code from being loaded directly into a memory in which executable applications and/or data are also located.

In further embodiments of the method, the security application can be designed to be loaded into the first internal memory or into an internal application memory of the security module, in order to be executed.

The fact that the security application is loaded into a special internal memory of the security module in order to run means that the security of the method can be increased even further.

In further embodiments of the method the security function and/or additional security functions can be provided by the security application and/or additional security applications.

Depending on the configuration, for example, one security application can provide a plurality of security functions. This allows different application scenarios to be implemented and adapted to the individual needs of the device. For example, security functions can be provided exclusively by the security application, in particular by means of the security module. A request can also contain a plurality of security applications which are executed in parallel or one after another, for example by means of a scheduler.

In further embodiments of the method a data exchange can take place between security applications in the security module by means of a third internal memory of the security module.

By means of the third internal memory, for example, a volatile memory, it is possible to use, for example, outputs of the security application as the input for a further security application if, for example, at any point in time only one security application can be contained in the security module. The outputs of the security application can be, for example, the data that are generated by the security function. This preferably allows complex and/or nested cryptographic functions to be implemented.

In further embodiments of the method, a number of security applications to be executed can be defined by the control application.

The (maximum) executable number of security applications is preferably limited by the control application. To this end, the number to be executed can be specified, for example, during the manufacture of the security module. If a new and/or additional security application is to be loaded, the control application compares the (maximum) number with the number of security applications executed. If the new application would cause the number to be executed to be exceeded (i.e. the number of applications being executed would be greater than the number to be executed), then according to a pre-defined scheme the control application can unload a security application that has already been loaded, which can also be considered as overwriting. For example, the pre-defined scheme can specify that a security application which is no longer needed will be overwritten. If the memory or the processing capacity of the security module is severely restricted, then it can be specified, for example, that only a single security application can be loaded and executed at a time. This has the advantage that the storage space required, for example on an FPGA, can be kept low.

In further embodiments of the method a number of security applications to be executed can be specified on the basis of authorization information, and/or the authorization information specifies whether
the security application can be loaded; and/or
the security application can be loaded from a memory external to the security module or from a different location; and/or
the device is in a specific operating mode, so that the security application can be loaded; and/or
predefined memory areas of the security module or cryptographic functions of the control application are accessible to the security application.

The authorization information can also be designated as license information or licensing information.

This allows the loading and execution of the security application to be easily controlled using the authorization information, for example a security policy or an authorization policy. For example, the (maximum) number of executable security applications can be limited. Alternatively and/or additionally, access to the predetermined memory areas, for example, pre-defined memory areas of the first internal memory, the second internal memory or the third internal memory, can be specified according to the security requirements.

In other embodiments of the method, the authorization information can be received as part of the request, the authorization information can be stored in the first internal memory or stored in a header information item of the security application.

This enables the authorization information to be provided to the security module or the control application in a flexible way by the first internal memory or another internal memory of the security module, for example, the second internal memory, the internal application memory and/or the third internal memory.

In other embodiments of the method, an application-specific cryptographic key can be provided when loading the security application.

In an alternative design the control application forms, for example, an application-specific cryptographic key or application-specific raw data, a so-called primary seed or private primary seed, to form a cryptographic key depending on identification information of the loaded security application.

This allows further improvement in the security of the method, because there is preferably only one cryptographic key for a security application, in order, for example, to verify a security information item in the form of a digital signature.

In other embodiments of the method, an application-specific identifier can be provided when loading the security application.

For example, to create an application-specific cryptographic key, the application-specific identifier, which can also be described as an identifier, can be integrated into the key generation in order to generate an application-specific cryptographic key in a reproducible way.

In other embodiments of the method, the method steps can be performed by the security module, in particular a trust anchor.

For example, by an exclusive execution of all method steps of the security module, a very high level of security of the method can be achieved. In this case, the module components or units of the security module to be mentioned below can be organized centrally or in a decentralized way.

In other embodiments of the method, during transfer of the security application an identity information item and/or a context information item can be transferred at the same time.

In other embodiments of the method, the security application can provide data for a security application executed thereafter.

In this way, the security functions of security applications can be chained together and complex application scenarios can preferably be implemented.

In other embodiments of the method, the request to load and execute the security application can be generated by the security module or the request can be generated externally to the security module.

This means the method can be used in a flexible way for different application scenarios.

A further aspect of embodiments of the invention relate to a security module, in particular a trust anchor for providing a security function, in particular a cryptographic function, for a device. The security module comprises a processor and a first internal memory. The security module also comprises an interface for receiving a request to perform the security function. The security module also comprises a loading unit for loading a security application for the security function by means of a control application, wherein the control application is stored on the first internal memory of the security module and the security application is transferred from a memory external to the security module. The security module also comprises a verification unit for verifying integrity of the security application by means of a security information item. The security module comprises an execution unit for executing the security application and for providing the security function, wherein the execution and provision are only carried out after the successful verification of the integrity.

The units of the security module can be organized in either a centralized or decentralized way.

A further aspect of embodiments of the invention relate to a device which has a security module according to embodiments of the invention and/or an application-specific security module according to the invention, or a plurality of application-specific security modules according to the invention.

An application-specific security module can be understood to mean a security module according to embodiments of the invention which, for example, only executes specific security applications based on an authorization information item. There may also be, for example, only one predefined security application executed on an application-specific security module. This allows, for example, the device to use a plurality of security applications in parallel on a plurality of security modules.

In addition, a computer program product (non-transitory computer readable storage medium having instructions, which when executed by a processor, perform actions) with program commands for implementing the said method according to embodiments of the invention is claimed.

In addition, an alternative design of the computer program product is claimed, having program commands for configuring a generation device, such as a 3D printer or similar device, wherein the generation device is configured with the program commands in such a way that the above-mentioned device according to embodiments of the invention is generated.

In addition, a delivery device for storing and/or delivering the computer program product is claimed. The delivery device is a data medium, for example, which stores and/or provides the computer program product. Alternatively and/or in addition, the delivery device is, for example, a network service, a computer system, a server system, in particular a distributed computer system, a cloud-based computing system and/or virtual computing system which stores and/or delivers the computer program product, preferably in the form of a data stream.

This delivery is implemented, for example, as a download in the form of a program data block and/or command data block, preferably as a file, in particular as a download file, or as a data stream, in particular as a download data stream, of the entire computer program product. This delivery can also be, for example, in the form of a partial download, which consists of a plurality of parts and in particular is downloaded over a peer-to-peer network or provided as a data stream. Such a computer program product is read into a system, for example using the delivery device in the form of the data medium, and executes the program commands so that the method according to embodiments of the invention is brought to execution on a computer, or else the generation device is configured in such a way that this generates the device according to the invention.

### BRIEF DESCRIPTION

Some of the embodiments will be described in detail, with reference to the following figures, wherein like designations denote like members, wherein:

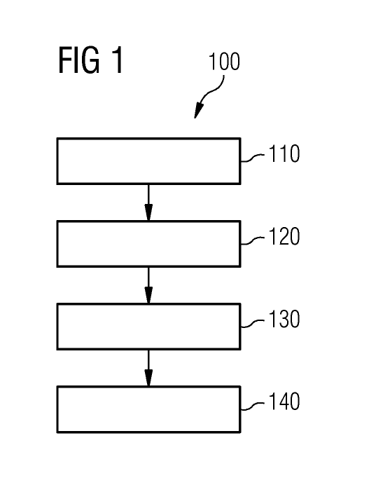

FIG. 1 depicts a flowchart of a first exemplary embodiment version of the disclosed method;

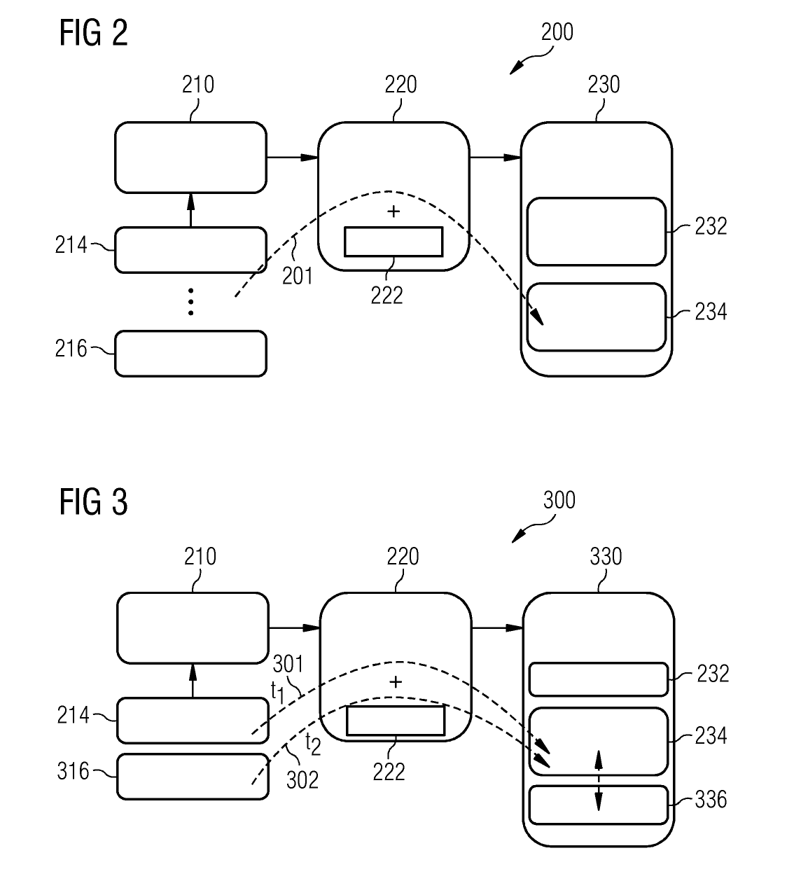

FIG. 2 depicts a provision of a security function by means of the disclosed method in a second exemplary embodiment;

FIG. 3 depicts provision of a security function by means of the disclosed method in a third exemplary embodiment;

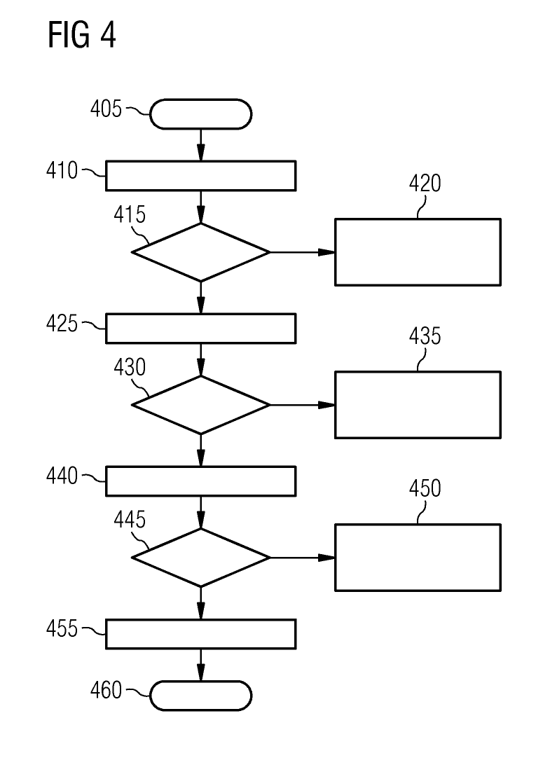

FIG. 4 depicts an authorized loading of a security application for providing a security function according to a fourth exemplary embodiment of the disclosed method;

FIG. 5 depicts a security module of a fifth exemplary embodiment; and

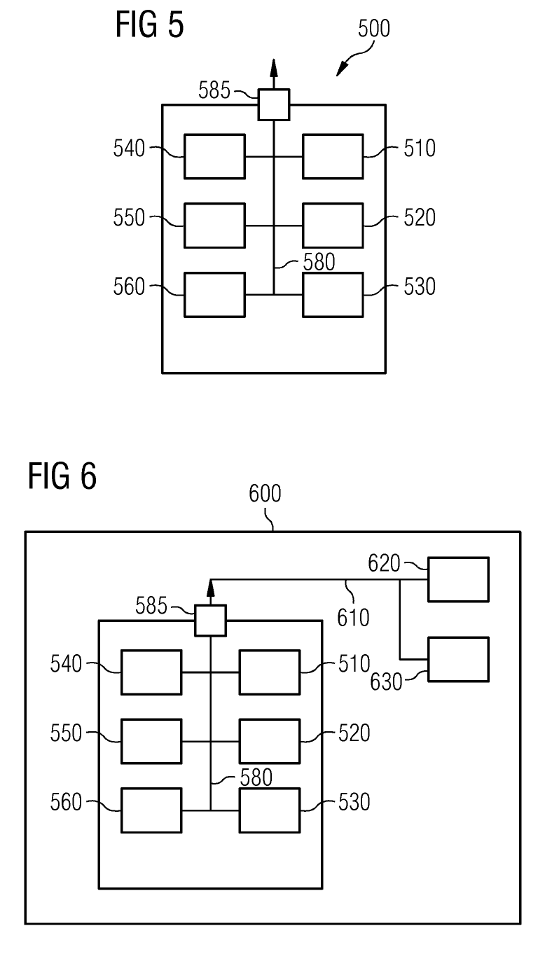

FIG. 6 depicts a device of a sixth exemplary embodiment.

### DETAILED DESCRIPTION

In the figures, functionally equivalent elements are provided with the same reference numerals, unless otherwise indicated.

FIG. 1 is a flow diagram of a first exemplary embodiment of the disclosed method 100.

The method 100 is capable of providing a device, such as a measuring device for high frequency technology, a measuring device, a control unit, a receiving device of a satellite communication station or a field device of a power plant, with a security feature, for example a cryptographic function.

In order to provide the security function, for example, a security module is installed in the device or the security module is a sub-component of the device, wherein the security module executes in particular a plurality, preferably all of the following method steps.

In a first method step a request to execute the security function is received, preferably via a communication interface. The security function can be, for example, a cryptographic function, which provides, in particular, cryptographic keys, digital certificates or cryptographic functions. The cryptographic functions can implement, for example, cryptographic techniques, such as the Advanced Encryption Standard (AES). Alternatively and/or additionally, for example, license information can be provided to enable functions of the device. The license information can enable, for example, measurement algorithms of a measuring device or enable frequency ranges, which can be processed by measurement algorithms.

In a second method step 120, a security application for the security function is loaded by means of a control application, wherein the control application is stored on a first internal memory of the security module and the security application is transferred from a memory external to the security module. The security application provides the requested security function.

During operation of the security module the control application is preferably executed internally to the security module, so that a change external to the security module, often also designated as an external change, is preferably prohibited for the control application.

The security application itself can be received, for example, as a part of the request. Additionally and/or alternatively, the request can also specify a memory location from which the security application can be loaded.

The security application is preferably loaded into the first internal memory or into an internal application memory of the security module. An external memory can be understood to mean a memory device, such as a hard drive of the device, which is not arranged inside the security module itself.

In an alternative design, the security application is selected by the control application. In this case, for example, one or more security applications can be permanently assigned to a specific security function. This assignment can be stored, for example, as a list, as a conversion table (or lookup table), or in the request.

In a third method step 130, the integrity of the security application is verified, for example, on the basis of a security information item, for example of integrity information. This can take place, for example, by means of an integrity information item in the form of a digital certificate, a digital signature or a checksum, which was contained in the request. An implementation using digital signatures can be realized, for example, with the RSA (Rivest, Shamir, Adleman), the Digital Signature Algorithm (DSA) or the ECDSA (Elliptic Curve Digital Signature Algorithm).

In an alternative design the security applications are stored in encrypted form and are decrypted using a first cryptographic key before the verification.

If the integrity check was successful, in a fourth method step 140 the security application is executed and the requested security function is provided via the communication interface, for example. In other words, the security application is executed as a result of a successful integrity check. Thus, in the event that the verification fails, execution of the security application and provision of the security function is blocked.

In other words, before executing the security application in the security module the integrity of the security application is checked. If the security application is encrypted, it is decrypted before being checked.

The “execution” of a security application can also be designated as the activation of the code or program code of the security application internal to the security module.

If, for example, the security application to be loaded is encrypted, this may have been carried out with a symmetric or an asymmetric cryptographic procedure. The first cryptographic key necessary for decrypting the security applications is preferably stored in the security module, for example, in the first internal memory. The first cryptographic key is preferably protected against accesses external to the security module, so that the control application preferably only has access to the first cryptographic key.

This first cryptographic key can be stored on the security module during the production of the security module, for example, or by means of a cryptographically protected update operation.

In other words, a method is disclosed in which an application, for example the security application of the security module, for example a trust anchor, does not need to be stored internally first of all, but can also be available externally, and that this can also be replaced, for example, by authorized entities. An authorized entity can be a component of the device, which sends a request to the trust anchor and can provide the necessary information for checking the integrity.

In this case the software which is provided on the trust anchor is initially limited to the control application. So, at first only the control application is preferably available on the trust anchor. In other words, data permanently stored on the trust anchor are limited to the control application, because the security application or additional security applications can be loaded into the trust anchor and can be deleted by the trust anchor.

The control application is able to load an application, for example the security application, into the trust anchor from an external memory or from the received request, wherein the control application is hard-coded in the trust anchor. This means that, in particular, the security function or other security functions that are to be provided by the trust anchor are preferably provided by means of downloading and execution of the security application or other security applications into the trust anchor.

Only one security application is preferably executed in the trust anchor at any one time. In order to provide a facility for security applications to securely pass on data, for example generated checksums or cryptographic keys, to subsequently loaded security applications, the trust anchor can have a second internal memory, for example a volatile memory, preferably used exclusively for this purpose.

The control application preferably remains unchanged during loading and execution of the security application. At the same time, the control application ensures, in particular, that the consistency, i.e. the correct execution of security functions, of preferably the entire system is ensured in the trust anchor.

In a first implementation variant, the consistency can be ensured by the fact that a new security application is loaded initially into a third internal memory, for example an intermediate buffer of the security anchor. As soon as the security application is loaded into the third internal memory, this security application is decrypted, if necessary, and checked for its integrity. If the integrity check is successful, the security application is executed, which can also be referred to as being switched to active mode. The previous security application can then be disabled and, if necessary, overwritten.

In the first implementation variant it is sufficient to check a digital signature or a Message Authentication Code (MAC) using the loaded security application after successful loading. If the integrity check fails, the buffer is enabled again and the loaded security application is not executed.

In a second implementation variant a newly loaded security application and the old security application, thus a previously loaded security application which is no longer needed, share a common memory area in the trust anchor. This memory area can preferably be in the first internal memory or the internal application memory of the trust anchor. The old security application is in particular already replaced when the new security application is loaded. In this case, it is preferably ensured that in the event of an error during loading it will still be possible to download a suitable security application.

In the second implementation variant, it may possibly be useful to initially transfer a header information item of the new security application and to check the integrity of this header information. Only after a check of the header information has been successful is the security application transferred as a result and the old security application replaced. A check of the integrity of the security application is preferably additionally carried out after the transfer is completed. The header information may incorporate information about the security application to be loaded, such as version, size and/or security functions to be executed.

In a further alternative design, by means of an authorization information item, for example a security policy in the form of an authorization policy, it is possible to specify which re-loadable security applications may be used and/or from which (data) source these security applications may originate. The following criteria/data can be used for such a security policy, for which a list is created, for example, which is frequently also referred to as an (application/security application) whitelist.

Security applications can be approved, for example, according to their source. It is possible, for example, to use the “SubjectName” and/or “SubjectAltName” of the digital certificate, with which the digital signature of the security application was created. Alternatively and/or additionally, the serial number and/or the issuer of the certificate, with which the digital signature of the security application was created, can also be used.

Security applications can also be approved according to their identification, however. It is possible, for example, to use an application-specific identifier of a security application for matching against a list of permitted security applications. Alternatively and/or additionally, a fingerprint of a security application can be used, for example in the form of a cryptographic hash value or a digital signature.

Alternatively and/or in addition to the list described, the authorization information can also be entered in the header information of the respective subsequently loadable security application. The advantage of this approach is that the authorization information is not explicitly loaded in the form of a list and therefore does not require additional memory space in the trust anchor.

In addition to the authorization information the operating mode of the device can additionally be included in the authorization for loading a security application. An example of this is: if the device is one with a specific security approval, in the case of a security-critical operation no code can be subsequently downloaded/exchanged. To do this, additional interfaces may be necessary on the trust anchor to evaluate this status information.

Furthermore, on the basis of the authorization information it is possible to define the cryptographic keys or cryptographic operations of the trust anchor that the security application can access. For this purpose, access to some predefined memory areas, such as key memory areas, predefined function calls or opcodes, can be blocked.

In a further alternative design, an application-specific cryptographic key for a loaded security application is provided.

This can be formed, for example, when loading the security application, or the application-specific cryptographic key can be formed when using a cryptographic operation or in the event of access to a key memory. The application-specific cryptographic key can be chosen at random, or it can be formed deterministically by a key derivation. An input to the key derivation is preferably a security application-dependent derivation parameter, for example, an application-specific identifier, a checksum of the security application, for example a cryptographic hash value, or information on the issuer of the security application. In particular, depending on a master key of the trust anchor an application-specific master key can be formed and provided to the security application as an application-specific master key.

The term master key here also refers to an information item which can be used to form one or more cryptographic keys, a so-called private primary seed. A private primary seed can be used as input parameters for different key forming functions to deterministically form a private key, or a key pair consisting of a private and a public key.

In a further alternative design, analogously to the provision of the application-specific cryptographic key, an application-specific identifier of the security application can be provided. This allows, for example, different application-specific identifiers to be provided for different security applications of the trust anchor. This ensures that a security application cannot use the same identifier as another security application of the same trust anchor. The identifier can be provided to the security application, for example in a cryptographically protected way (certification), or else it can be used in a key derivation procedure initiated by the security application, as a derivation parameter.

FIG. 2 shows the provision of a security function by a security module of a second exemplary embodiment 200. Specifically, an alternative design of the method is used, which has been described in FIG. 1.

FIG. 2 shows a security module 230, which comprises a control application 232. In addition, FIG. 2 shows components external to the security module, such as an operating system 220, for example a Linux kernel, with drivers 222, a loading application 210 of the operating system 220, a first security application 214 and an n-th security application 216. The components external to the security module can be part of a device in which the security module 230 is installed.

The security module 230 is a trust anchor, for example, which is implemented as an FPGA module. The integrity of the security applications is protected with a cryptographic algorithm, for example the HMAC-SHA256 (Keyed Hash Message Authentication Code, Secure Hash Algorithm 256), and stored together with the security applications as integrity information in a memory external to the security module. The loading application 210 of the operating system 220 selects the first security application 214, for example, so that the trust anchor 230 executes and provides a security function of the first security application 214.

For this purpose, the loading application 210 transfers the first security application 214 with the integrity information, for example a digital signature using the integrity information, to the operating system 220, so that the operating system 220 can carry out a data transfer 201 to the security anchor 230 using the driver 222 and place a request to provide the security function of the first security application 214.

The driver 222 thus sends a request, which comprises the security application and the integrity information, to the trust anchor 230, so that the trust anchor executes the first security application 214 and provides the security function. For this purpose the first security application 214 is loaded by the control application 232 into a second internal memory of the trust anchor, and the control application 232 then checks the integrity of the first security application 214 with the aid of the integrity information.

Only if the integrity check of the first security application 214 was successful is this deemed a security application 234 to be executed in the trust anchor 230.

The control application 232 then loads the first security application 214, for example from the second internal memory into a first internal memory of the trust anchor, or into an internal application memory of the trust anchor. The first security application 214 is then executed and the requested security function is provided to the operating system 220.

FIG. 3 shows a provision of a security function by a security module of a third exemplary embodiment 300. Specifically, an alternative design of the method is used, which has been described in FIG. 1.

FIG. 3 shows a security module 330, which comprises a control application 232 and a third internal memory 336 of the security module 330. In addition, FIG. 3 shows components external to the security module, such as an operating system 220, for example a Linux kernel, with drivers 222, a loading application 210 of the operating system 220, a first security application 214 and second security application 316. The components external to the security module can be part of a device in which the security module 330 is installed.

The security module 330 is a trust anchor, for example, which is implemented as an FPGA module. The integrity of the security applications is protected with a cryptographic algorithm, for example the HMAC-SHA256 (Keyed Hash Message Authentication Code, Secure Hash Algorithm 256), and stored together with the security applications as integrity information in a memory external to the security module. The loading application 210 of the operating system 220 selects the first security application 214 at a first time t₁, so that the trust anchor 230 executes and provides a first security function of the first security application 214.

The loading application 210 of the operating system 220 selects the second security application 316, for example, at time t₂, so that the trust anchor 230 executes and provides a second security function of the second security application 316.

For this purpose the loading application 210 transfers the first security application 214 with the associated integrity information, for example a digital signature using the integrity information, to the operating system 220, so that the operating system 230 can carry out a first data transfer 301 using the driver 222 to the security anchor 330 at the first time t₁ and place a first request to provide the security function of the first security application 214.

Similarly, a second data transfer 302 is carried out at the second time t₂ for the second security application 316. The second security function is then provided in the same way as the first security function.

For this purpose, the driver 222 sends the first request, which comprises the first security application 214 and the associated integrity information items, to the trust anchor 330 at the first time t₁, so that the trust anchor 330 executes the first security application 214 and provides the first security function.

The driver 222 thus sends, for example, a second request at time t₂, which comprises the second security application 316 and the associated integrity information, to the trust anchor 330, so that the trust anchor 330 executes the second security application 316 and provides the second security function.

First of all, the first security application 214 is loaded by the control application 232 into a second internal memory of the trust anchor, and the control application 232 then checks the integrity of the first security application 214 with the aid of the integrity information.

Only if the integrity check of the first security application was successful is this deemed a security application 234 to be executed in the trust anchor 230.

The control application 232 then loads the first security application 214, for example from the second internal memory into a first internal memory of the trust anchor, or into an internal application memory of the trust anchor. The first security application 214 is then executed and the requested security function is provided to the operating system 220, the trust anchor 330 or the control application 232. The first security application 214 or the first security function can also generate data which are stored on a third internal memory 336 of the security module, so that the second security application 316 can use them at a later date.

If the second security application 316 is loaded and executed in an analogous way to the first security application 214, the second security function can read the data generated by the first security function out of the third internal memory 336 and process it.

In this way, as many security applications as desired can be loaded one after another and the security applications can exchange data via the third internal memory 336 in a securely protected manner.

Due to this consecutive activation of security applications, it is possible to implement complex functionalities, which overall would exceed the available resources of the trust anchor, by means of a sequence of security applications. For example, the calculation of a SHA256-ECDSA signature can be split into the calculation of the hash (SHA256) and the signature (ECDSA). The first security application 214 computes the SHA256 hash, also called the checksum. The second security application 316 computes a digital signature. The required intermediate value (hash value) is exchanged via the third internal memory 336.

The trust anchor may also implement a stack machine, for example, which downloads individual commands.

In an alternative design, the first request already contains all the security applications to be executed, their integrity information and information about the requested security functions.

In a further alternative design, the first security application provides data for a security application executed thereafter. In particular, this enables, for example, an authorization to be implemented by the first security application 214 for the second security application 316. In this case, in addition to the (optional) intermediate values, the first security application stores an authentication token, for example in the third internal memory 336 of the security module 330. The authentication token is evaluated before the calculation is continued. There are two conceivable implementation variants of this:

In the first implementation variant the first security application or the first security function specifies a restriction that only certain security applications can be subsequently downloaded and/or executed. The restriction is enforced by the control application 232 of the trust anchor.

In the second implementation variant an acceptance of intermediate results of previously executed security applications, for example the first security application 214, is restricted by the second security application 316 to predefined intermediate results. The restriction is enforced in the second implementation of the second security application 316.

In a further alternative design, the previous exemplary embodiments can be extended such that in addition to the verification of the integrity, the authorization for reloading of specific security applications is verified. The associated authorization information can be created by the device operator and can be provided, for example, in the form of a signed information item. For this purpose, the control application is provided with an extension that enables owner information or operator information items to be specified. This can be implemented either at the production stage or during initial installation. A possible process sequence during loading in the alternative design with external authorization information, for example an authorization policy, is shown in FIG. 4 from the point of view of the security module.

Specifically, FIG. 4 shows a flow diagram with a Start element 405 and an End element 460.

In a first method step 410, for example, an attempt is made to read the owner information or the operator information. In a second method step 415, a check is performed to determine whether the owner information or the operator information was readable.

If the check fails, which means the owner information or the operator information is absent, then, for example in a method step 420 either a (data) source of the additional security application to be loaded or else a kind, for example, a certain type of security applications, such as encryption applications, of the additional security application to be loaded is accepted for loading and execution without restriction.

If the verification is successful, i.e. if the owner information or operator information is present, then in a method step 425, for example, the authorization information is loaded and the authenticity of the authorization information is verified.

In a method step 430 it is then decided which further method steps are to be executed based on the result of the verification.

If the verification fails, in a method step 435 an error message is displayed, for example, and the security application is not loaded and/or executed.

If the verification is successful, for example, in a method step 440 the security application is loaded and its integrity checked. Alternatively and/or in addition, the authorization information is loaded and the security application and/or its security function are checked to determine whether they are executable.

In a method step 445, a decision is taken on whether to execute the security application on the basis of an outcome of the integrity check and/or authorization information.

If the verification is successful, for example, in a method step 455 the security application is executed and the security function of the security application is provided to the user who requested it.

If the verification fails, then for example in a method step 450, an error message is issued and the execution of the security application is blocked.

FIG. 5 shows a security module 500 of a fifth exemplary embodiment.

The security module 500, which is implemented for example as a trust anchor, provides a security function, such as a cryptographic function, for a device. The security module 500 comprises a processor 510, a first internal memory 520, a loading unit 530, a verification unit 540, an execution unit 550 and an interface 585, which are in communicative connection with each other by means of a first bus 580.

Specifically, the interface 585 receives a request to execute a security function. The loading unit 530 loads a security application for the security function by means of a control application, wherein the control application is stored on a first internal memory 520 of the security module 500 and the security application is transferred from a memory external to the security module.

The security application is then executed, for example by the processor 510 internally to the security module, so that the method disclosed in FIGS. 1-4 can be executed on a computer.

The verification unit 540 checks the integrity of the security application on the basis of a security information item. The execution unit 550 executes the security application and deploys the security function, for example via the interface 585, wherein the execution and deployment are carried out only after successfully verifying the integrity.

The security module can be integrated for example, in a device 600, as shown in FIG. 6. The device 600 may be, for example, an embedded system, a heart pacemaker, a field device of a power plant, or a control unit of a fire extinguishing system.

Specifically the device 600 comprises a security module 500, as is described in FIG. 5. In addition, the device comprises an operating system component 620 and a driver component 630, which are in communicative connection with the security module via a second bus 610.

If the operating system component 620 requires a security function, this sends a request via the second bus 610 to the security module 500 to execute the security function, using the driver component 630. The security module will then, as described in the previous exemplary embodiments, provide the security function, at least if the integrity of a security application that provides the security function has been successfully verified.

Although the invention has been illustrated and described in greater detail by means of the exemplary embodiments, the invention is not restricted by the examples disclosed, and other variations can be derived therefrom by the person skilled in the art without departing from the scope of protection of the invention.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for providing a cryptographic function for a device, the method comprising:
receiving a request to execute the cryptographic function;
loading a security application for the cryptographic function using a control application, wherein
the control application is stored on a first internal memory of a security module;
the security application is transferred from a memory which is external to the security module;
verifying an integrity of the security application by means of a security information item; and
executing the security application and providing the security function, wherein the execution and provision steps are carried out after the successful verification of the integrity.

2. The method as claimed in claim 1, wherein the security application is decrypted using a first cryptographic key before the verification.

3. The method as claimed in claim 1, wherein
before the security information is verified, the integrity of a header information item of the security application is verified; and
the security application is loaded only after successful verification of the header information.

4. The method as claimed in claim 1, wherein the security application is transmitted as a part of the request, a memory location of the security application is transmitted as part of the request, or the security application is loaded by the control application from the memory external to the security module.

5. The method as claimed in claim 1, wherein for decryption, verification of the security application or verification of the header information, the security application is loaded into a second internal memory.

6. The method as claimed in claim 1, wherein for its execution, the security application is loaded into the first internal memory or into an internal application memory of the security module.

7. The method as claimed in claim 1, wherein the cryptographic function and/or additional security functions are provided by the security application and/or by other security applications.

8. The method as claimed in claim 1, wherein a data exchange between security applications takes place in the security module via a third internal memory of the security module.

9. The method as claimed in claim 1, wherein a number of security applications to be executed is defined by the control application.

10. The method as claimed in claim 1, wherein on the basis of authorization information a number of security applications to be executed is defined, and/or on the basis of the authorization information it is defined whether
the security application can be loaded; and/or
the security application can be loaded from the memory external to the security module or from another memory location; and/or
the device is in a specific operating mode, so that the security application can be loaded; and/or
predefined memory areas of the security module or cryptographic functions of the control application are accessible to the security application.

11. The method as claimed in claim 10, wherein the authorization information is received as part of the request, the authorization information is stored in the first internal memory or is stored in a header information item of the security application.

12. The method as claimed in claim 1, wherein when loading the security application an application-specific cryptographic key is provided.

13. The method as claimed in claim 1, wherein when loading the security application an application-specific identifier is provided.

14. The method as claimed in claim 1, wherein the method steps are implemented by a trust anchor.

15. The method as claimed in claim 1, wherein when transferring the security application an identity information item and/or a context information item is/are transmitted at the same time.

16. The method as claimed in claim 1, wherein the security application provides data for a security application performed thereafter.

17. The method as claimed in claim 1, wherein the request to load and execute the security application is generated by the security module or the request is generated externally to the security module.

18. A security module, for providing a cryptographic function, for a device, comprising:
a processor;
a first internal memory;
an interface for receiving a request to execute the cryptographic function;
a loading unit for loading a security application for the cryptographic function by means of a control application, wherein:
the control application is stored on the first internal memory of the security module;
the security application is transferred from a memory external to the security module;
a verification unit for verifying the integrity of the security application by means of a security information item; and
an execution unit for executing the security application and providing the security function, wherein the execution and provision is only carried out after the successful verification of the integrity.

19. A device which has at least one application-specific security module as claimed in claim 18.

20. A computer program product comprising a computer readable hardware storage device having computer readable program code stored therein, said program code executable by a processor of a computer system to implement a method as claimed in claim 1.

21. The computer program product, with program commands for a generation device, which is configured using the program commands to generate the security module as claimed in claim 18.

22. A delivery device for the computer program product as claimed in claim 20, wherein the delivery device stores and/or provides the computer program product.
